(19) United States
(12) Patent Application Publication
(10) Pub. No.: US 2014/0063670 A1
(43) Pub. Date: Mar. 6, 2014

(54) BATTERY PROTECTION CIRCUIT AND BATTERY PACK INCLUDING THE SAME

(71) Applicant: Samsung SDI Co., Ltd., Yongin-city (KR)

(72) Inventor: Se-Jin Ji, Yongin-si (KR)

(73) Assignee: Samsung SDI Co., Ltd., Yongin-city (KR)

(21) Appl. No.: 13/903,870

(22) Filed: May 28, 2013

Related U.S. Application Data
(60) Provisional application No. 61/696,672, filed on Sep. 4, 2012.

(51) Int. Cl. H02J 7/00

(52) U.S. Cl. CPC H02J 7/0029
USPC 361/90

(57) ABSTRACT

A battery protection circuit and a battery pack are disclosed. The battery pack includes the battery protection circuit, which has a switching unit and a control circuit, which controls the switching unit with a control signal. The battery protection circuit also has an external terminal, which is configurable to electrically connect the control signal to a circuit external to the battery protection circuit.

### RELATED APPLICATIONS

This application claims priority under 35 U.S.C. §119(e) to U.S. Provisional Application No. 61/696,672, filed on Sep. 4, 2012, the entire content of which is incorporated herein by reference.

### BACKGROUND

1. Field

The disclosed technology relates to a battery protection circuit and a battery pack including the same, and more particularly, to a battery protection circuit and a battery pack that includes a terminal capable of being connected to a gate electrode of a transistor for charging/discharging control, so that the turn-on resistance of the transistor can be easily controlled. Accordingly, efficient battery management is possible.

2. Description of the Related Technology

Recently, portable electronic/electrical devices which are compact in size and light in weight, such as cellular phones, notebook computers, and camcorders, have been actively developed and produced. The portable electronic/electrical devices have batteries so as to be operated locations where a separate power source is not provided.

Damage to a battery may occur due to its ignition, rupture, or explosion if the battery experiences overcharging, overdischarging, or overcurrent caused by a short circuit between terminals because of, for example, chemical properties of the battery. Therefore, as can be seen in a battery pack 100 shown in FIG. 1, a battery protection circuit 120 that protects a bare cell 110 by detecting overcharging, overcurrent and over discharging of the bare cell 110 is included in the related art battery pack 100.

The battery protection circuit 120 may be manufactured in the form of an integrated circuit (IC) chip. The battery protection circuit 120 includes a control IC 130 and a switching unit 140 therein, so as to perform a protecting operation of the bare cell 110. Generally, the switching unit 140 is configured to include a transistor 141 for discharging control and a transistor 142 for charging control, which are controlled by the control IC 130.

As can be seen in FIG. 1, the battery protection circuit 120 includes separate terminals T1, T2 and T3 through which external connection to source/drain electrodes of each of the transistors 141 and 142 for charging/discharging control is made. However, the battery protection circuit 120 does not include a separate external terminal for electrical connection to a gate electrode of the transistors 141 and 142 for charging/discharging control.

The gate electrodes of the transistors 141 and 142 may be controlled to adjust the internal resistance of the battery pack 100. However, since the gate electrodes of the transistors 141 and 142 for charging/discharging control are not exposed to the outside, there exists a problem that the turn-on resistance of the transistors 141 and 142 for charging/discharging control cannot be controlled by an external source.

### SUMMARY

Another inventive aspect is a battery pack, including a battery cell, and a battery protection circuit formed as an integrated circuit and configured to protect the battery cell, the battery protection circuit including a switching unit, configured to control charging and discharging of the battery cell according to a control signal received at a control input, a control circuit configured to generate the control signal, and at least one external terminal configured to electrically connect the control input to a circuit external to the battery protection circuit.

Another inventive aspect is a battery protection circuit formed as an integrated circuit and configured to protect a battery cell, the battery protection circuit including a switching unit, configured to control charging and discharging of the battery cell according to a control signal received at a control input, a control circuit configured to generate the control signal, and an external terminal configurable to electrically connect the control input to a circuit external to the battery protection circuit.

### BRIEF DESCRIPTION OF THE DRAWINGS

The accompanying drawings, together with the specification, illustrate exemplary embodiments, and, together with the description, serve to explain various inventive principles and aspects.

FIG. 1 is a circuit diagram showing a battery pack.

FIG. 2 is a circuit diagram showing a battery pack according to an embodiment.

FIG. 3 is a circuit diagram showing a configuration of a control IC for the embodiment of FIG. 2.

FIG. 4 is a circuit diagram showing a battery pack according to another embodiment.

### DETAILED DESCRIPTION

Hereinafter, certain exemplary embodiments are described with reference to the accompanying drawings. When a first element is described as being connected to a second element, the first element may be not only directly connected to the second element but may alternatively be indirectly connected to the second element via a third element. Further, some of the elements that are not essential to the complete understanding of the invention may be omitted for clarity. Also, like reference numerals generally refer to like elements throughout.

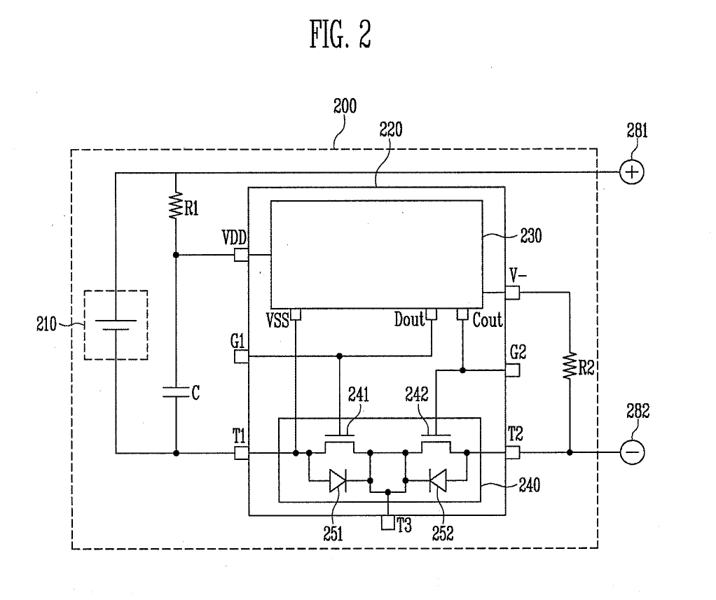

FIG. 2 is a circuit diagram showing a battery pack according to an embodiment. Referring to FIG. 2, the battery pack 200 according to this embodiment includes a bare cell 210 and a battery protection circuit 220.

The bare cell 210 may one or more bare cells, and a plurality of bare cells 210 may be connected in series and/or parallel. Positive and negative electrode terminals 281 and 282 connectable to a charger (not shown), electronic product (not shown), or the like may be formed on a high current path of the bare cell 210.

The battery protection circuit 220 is used to solve a problem that occurs due to an abnormal state (e.g. overcharging, overdischarging, overcurrent or the like) of the bare cell 210. The battery protection circuit 220 is connected to the bare cell 210 so as to perform a protecting operation of the bare cell 210. The battery protection circuit 220 may be manufactured as an integrated circuit (IC) chip.

Referring FIG. 2, the battery protection circuit 220 includes a control circuit, such as exemplary control circuit control IC 230 and a switching unit 240. The control IC 230 performs a function of detecting an abnormal state of the bare cell 210. For example, the control IC 230 may detect an abnormal state such as overcharging, overdischarging or over current.

The control IC 230 may control a charging/discharging state of the bare cell 210 by controlling the switching unit 240. The switching unit 240 includes at least one transistor for controlling the charging/discharging of the bare cell 210, and the operation of the switching unit 240 may be controlled by the control IC 230.

A gate electrode of the at least one transistor included in the switching unit 240 may be connected to a gate connection terminal of the battery protection circuit 220, which is also an electrode terminal for a connection outside of the battery protection circuit 220. The switching unit 240 may include a switch, such as a transistor 241 for discharging control and a switch, such as a transistor 242 for charging control, which will be described further below.

In this case, a gate electrode of the transistor 241 for discharging control may be connected to a first external terminal, such as first gate connection terminal G1 of the battery protection circuit 220, which is exposed to the outside, and a gate electrode of the transistor 242 for charging control may be connected to a second external terminal, such as second gate connection terminal G2 of the battery protection circuit 220, which is also exposed to the outside.

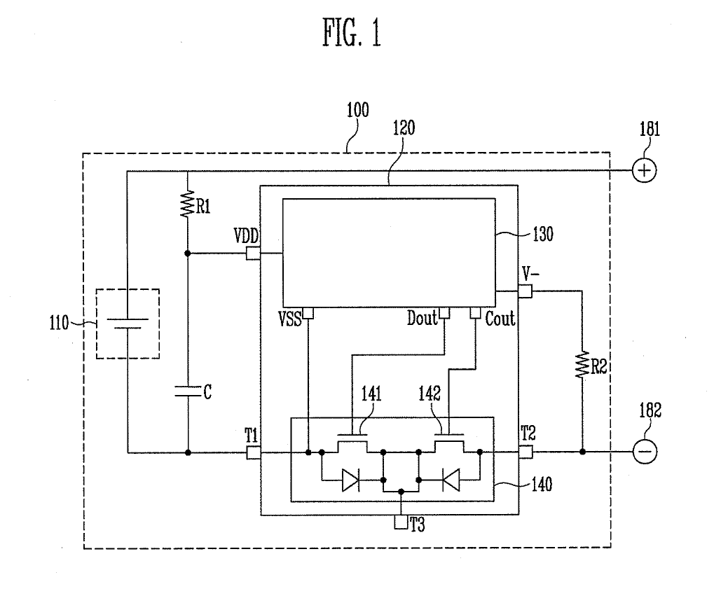

As can be seen in FIG. 1, the gate electrodes of the transistors 141 and 142 included in the switching unit 140 are connected to the control IC 130 in the battery protection circuit 120. Accordingly, the gate electrodes of the transistors 141 and 142 cannot be directly accessed from the outside, and therefore, the gate electrodes of the transistors 141 and 142 cannot be controlled from the outside to, for example, adjust internal resistance.

In contrast, the gate electrodes of the transistors 241 and 242 included in the switching unit 240 are exposed to the outside through the respective gate connection terminals G1 and G2, and thus the turn-on resistance of each of the transistors 241 and 242 can be controlled from the outside.

The connection relationship between the transistor 241 for discharging control and the transistor 242 for charging control is described. A first electrode of the transistor 241 for discharging control may be connected to a first terminal T1 of the battery protection circuit 220, which is exposed to the outside, and a second electrode of the transistor 241 for discharging control may be connected to a second electrode of the transistor 242 for charging control. In addition a first electrode of the transistor 242 for charging control may be connected to a second terminal T2 of the battery protection circuit 220, which is exposed to the outside.

For example, the first and second electrodes of the transistor 241 for discharging control may be source and drain electrodes, respectively. In addition, the first and second electrodes of the transistor 242 for charging control may source and drain electrodes, respectively.

The transistor 241 for discharging control and the transistor 242 for charging control are associated with diodes 251 and 252 connected in parallel thereto, respectively. Thus, power can be supplied to the transistor 241 for discharging control and the transistor 242 for charging control through the respective diodes 251 and 252 in the charging or discharging of the transistor 241 for discharging control and the transistor 242 for charging control, in which either the transistor 241 for discharging control or the transistor 242 for charging control is turned off

The second electrode of the transistor 241 for discharging control and the second electrode of the transistor 242 for charging control may be connected to a third terminal T3 of the battery protection circuit 220, which is exposed to the outside.

The transistor 241 for discharging control and the transistor 242 for charging control may be either N-MOS or P-MOS transistors.

The battery protection circuit according to this embodiment include the first and second gate connection terminals G1 and G2 and the first, second and third terminals T1, T2 and T3.

In this embodiment, the first terminal T1 is connected to a negative electrode of the bare cell 210, and the second terminal T2 is connected to the negative electrode terminal 282 of the battery pack 200.

The battery protection circuit 220 may include a power terminal VDD connected to a positive electrode of the bare cell 210 and an auxiliary terminal V− connected to the negative electrode terminal 282 of the battery pack 200.

As shown in FIG. 2, a resistor R1 may be provided between the positive electrode of the bare cell 210 and the power terminal VDD, and a capacitor C may be provided between the power terminal VDD and the first terminal T1 of the battery protection circuit 220. Furthermore, a resistor R2 may be provided between the auxiliary terminal V− and the negative electrode terminal 282 of the battery pack 200.

In this embodiment, the first and second gate connection terminals G1 and G2 are formed at positions opposite to each other for convenience of circuit design. In a case where the first gate connection terminal G1 is formed at one side of the battery protection circuit 220, the second gate connection terminal G2 may be formed at the other side of the battery protection circuit 220.

In this embodiment, the first terminal T1 is formed adjacent to the first gate connection terminal G1, and the second terminal T2 is formed adjacent to the second gate connection terminal G2. As an example, as shown in FIG. 2, the power terminal VDD, the first gate connection terminal G1 and the first terminal T1 are sequentially positioned at the one side of the battery protection circuit 220 from the top of this figure, and the auxiliary terminal V−, the second gate connection terminal G2 and the second terminal T2 are sequentially positioned at the other side of the battery protection circuit 220 from the top of this figure.

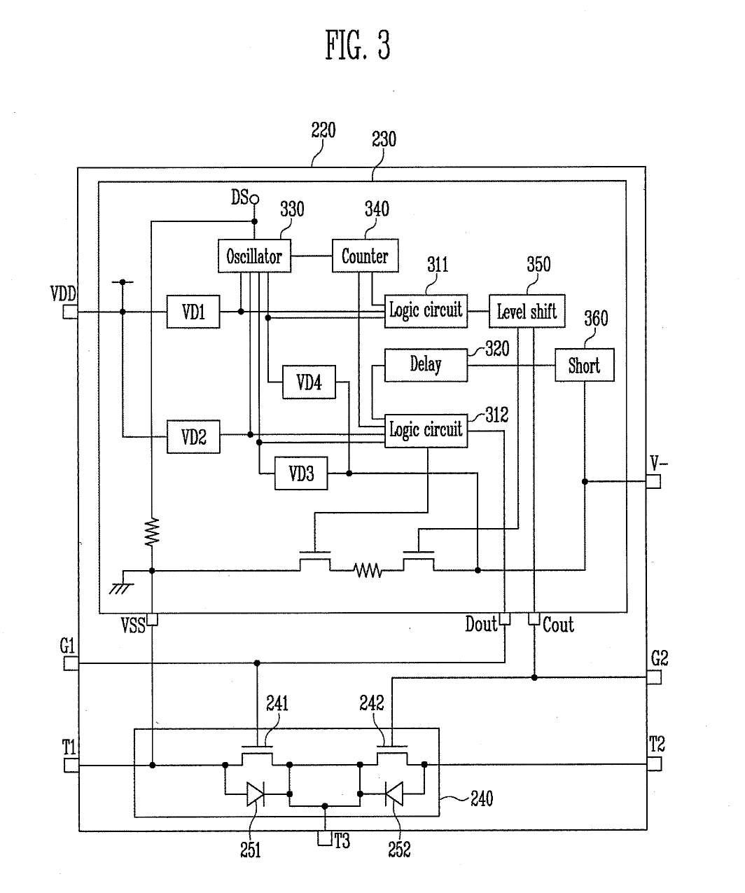

FIG. 3 is a circuit diagram showing an embodiment of the control IC 230 for the battery pack of FIG. 2.

Referring to FIG. 3, the control IC 230 according to this embodiment includes an overcharging detection unit VD1 that detects overcharging of the bare cell 210, an overdischarging detection unit VD2 that detects overdischarging of the bare cell 210. The control IC 230 also includes discharging and charging overcurrent detection units VD3 and VD4 that detect overcurrent of the bare cell 210, a first logic circuit 311, a second logic circuit 312, a delay circuit 320, an oscillator 330, a counter 340, a level shift circuit 350, and a short detection circuit 360.

The control IC 230 is connected to the power and auxiliary terminals VDD and V− of the battery protection circuit 220. The control IC 230 includes a ground terminal VSS, a discharging control terminal Dout, and a charging control terminal Cout, which are connected to the switching unit 240. The control IC 230 includes a DS terminal connected to the oscillator 330.

As shown, the ground terminal VSS of the control IC 230 may be connected to the first terminal T1 and the first electrode of the transistor 241 for discharging control with the switching unit 240, and the discharging control terminal Dout may be connected to the first gate connection terminal G1 and the gate electrode of the transistor 241 for discharging control included in the switching unit 240. The charging control terminal Cout may be connected the second gate connection terminal G2 and the gate electrode of the transistor 242 for charging control with the switching unit 240.

Hereinafter, certain operations performed by the battery protection circuit 220 are described.

If overcharging, overdischarging, discharging overcurrent, charging overcurrent or short circuit is detected by the overcharging detection unit VD1, the overdischarging detection unit VD2, the discharging overcurrent detection unit VD3, the charging overcurrent detection unit VD4 or the short detection circuit 360, the oscillator 330 is activated, and the counter 340 starts counting.

In a case where the overcharging or charging overcurrent is detected, a predetermined detection delay time is measured with the counter 340, and the output of the charging control terminal Cout is then switched to a low level through the logic circuit 311 and the level shift circuit 350. As a result, the transistor 242 for charging control is turned off.

In a case where the overdischarging, discharging overcurrent or short circuit is detected, the output of the discharging control terminal Dout is switched to a low level through the logic circuit 312. As a result, the transistor 241 for charging control is turned off.

The configuration and operation of the control IC 230 described above is merely an embodiment, and may be variously modified.

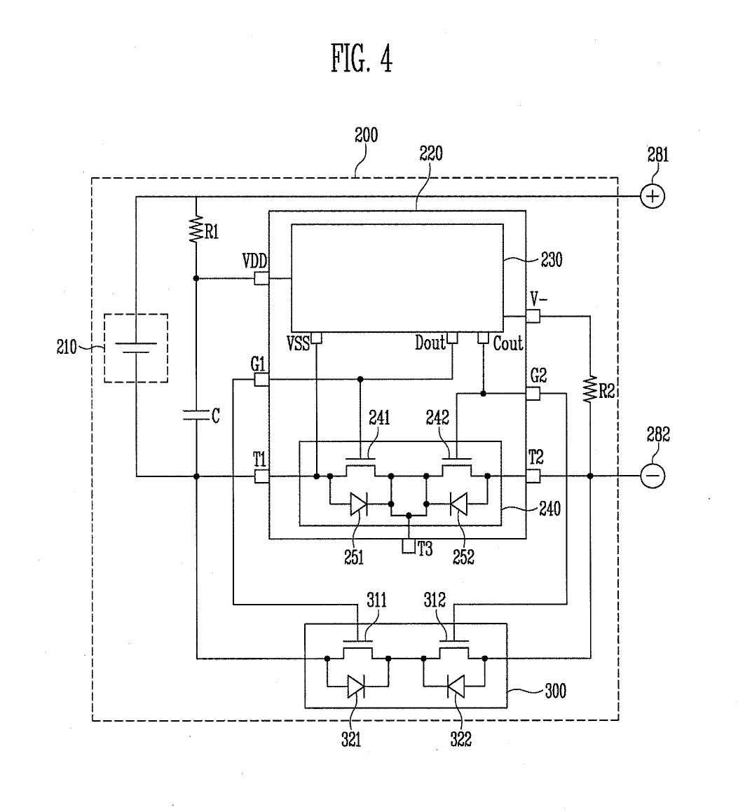

FIG. 4 is a circuit diagram showing a battery pack according to another embodiment. Referring to FIG. 4, the battery pack 200 according to this embodiment further includes an auxiliary switching unit 300.

The auxiliary switching unit 300 is provided to adjust the internal resistance of the battery pack 200, i.e., the resistance of the switching unit 240 on the high current path. The auxiliary switching unit 300 may include at least one transistor connected in parallel to the transistor 241 for discharging control and the transistor 242 for charging control, which are included in the switching unit 240.

In this case, the auxiliary switching unit 300 is configured in the same form as the switching unit 240. Accordingly, the auxiliary switching unit 300 may include a first transistor 311 and a second transistor 312. The first and second transistors 311 and 312 may be connected in series between the first and second terminals T1 and T2 so as to be positioned in parallel to the transistor 241 for discharging control and the transistor 242 for charging control.

Specifically, a first electrode of the first transistor 311 is connected to the first terminal T1, and a second electrode of the first transistor 311 is connected to a second electrode of the second transistor 312. In addition, a first electrode of the second transistor 312 may be connected to the second terminal T2. As an example, the first and second electrodes of the first transistor 311 may be source and drain electrodes, respectively. In addition, the first and second electrodes of the second transistor 312 may be source and drain electrodes, respectively.

In order to perform the same function as the switching unit 240, the auxiliary switching unit 300 may be provided with auxiliary diodes 321 and 322 respectively connected in parallel to the first and second transistors 311 and 312. In order to perform the same operation as the transistor 241 for discharging control, a gate electrode of the first transistor 311 may be connected to the first gate connection terminal G1. In order to perform the same operation as the transistor 242 for charging control, a gate electrode of the second transistor 312 may be connected to the second gate connection terminal G2.

Although one switching unit 240 is illustrated in FIG. 4, the number of switching units 240 may be variously changed. Accordingly, the separate gate connection terminals G1 and G2 are added to the battery protection circuit 220, so that the auxiliary switching unit 300 for adjusting the internal resistance of the battery pack 200 can be added to the battery pack 200 without changing the form of the battery protection circuit 220 manufactured in the form of the IC chip.

While the present invention has been described in connection with certain exemplary embodiments, it is to be understood that the invention is not limited to the disclosed embodiments, but, on the contrary, is intended to cover various modifications and equivalent arrangements.

1. A battery pack, comprising:
a battery cell; and
a battery protection circuit formed as an integrated circuit and configured to protect the battery cell, the battery protection circuit comprising:
a switching unit, configured to control charging and discharging of the battery cell according to a control signal received at a control input,
a control circuit configured to generate the control signal, and
at least one external terminal configured to electrically connect the control input to a circuit external to the battery protection circuit.

2. The battery pack according to claim 1, wherein the battery protection circuit comprises a positive power input terminal configured to receive power from the battery cell.

3. The battery pack according to claim 1, wherein the battery protection circuit comprises a negative power input terminal configured to conduct current from the battery protection circuit to the battery cell.

4. The battery pack according to claim 1, wherein the battery protection circuit further comprises a power terminal, wherein the switching unit is connected to a switching unit terminal, and wherein the external terminal is located between the power terminal and the switching unit terminal.

5. The battery pack according to claim 1, further comprising an auxiliary switching unit, comprising an auxiliary control input electrically connected to the external terminal.

6. The battery pack according to claim 5, wherein the auxiliary switching unit and the switching unit respectively comprise first and second switches.

7. The battery pack according to claim 6, wherein the control input of the switching unit comprises first and second terminals, respectively corresponding to the first and second switches of the switching unit, and wherein the auxiliary control input of the auxiliary switching unit comprises first and second auxiliary terminals, respectively corresponding to the first and second switches of the auxiliary switching unit.

8. The battery pack according to claim 6, wherein the at least one external terminal comprises first and second external terminals and the first external terminal is connected to the first terminal of the switching unit and to the first switch of the auxiliary switching unit, and the second external terminal is connected to the second terminal of the switching unit and to the second switch of the auxiliary switching unit.

9. The battery pack according to claim 5, wherein the battery protection circuit comprises a positive power input terminal configured to receive power from the battery cell.

10. The battery pack according to claim 5, wherein the battery protection circuit comprises a negative power input terminal configured to conduct current from the battery protection circuit to the battery cell.

11. The battery pack according to claim 5, wherein the battery protection circuit further comprises a power terminal, wherein the switching unit is connected to a switching unit terminal, and wherein the external terminal is located between the power terminal and the switching unit terminal.

12. A battery protection circuit formed as an integrated circuit and configured to protect a battery cell, the battery protection circuit comprising:
a switching unit, configured to control charging and discharging of the battery cell according to a control signal received at a control input;
a control circuit configured to generate the control signal; and
an external terminal configurable to electrically connect the control input to a circuit external to the battery protection circuit.

13. The battery protection circuit according to claim 12, wherein the switching unit comprises first and second switches.

14. The battery protection circuit according to claim 13, wherein the control input of the switching unit comprises first and second terminals, respectively corresponding to the first and second switches.

15. The battery protection circuit according to claim 13, wherein the external terminal comprises first and second external terminals and the first external terminal is connected to the first terminal of the switching unit and the second external terminal is connected to the second terminal of the switching unit.

16. The battery protection circuit according to claim 12, further comprising a positive power input terminal configured to receive power from the battery cell.

17. The battery protection circuit according to claim 12, further comprising a negative power input terminal configured to conduct current from the battery protection circuit to the battery cell.

18. The battery protection circuit according to claim 12, further comprising a power terminal, wherein the switching unit is connected to a switching unit terminal, and wherein the external terminal is located between the power terminal and the switching unit terminal.
